(19) United States
(12) Patent Application Publication
(10) Pub. No.: US 2026/0028957 A1
(43) Pub. Date: Jan. 29, 2026

(54) IGNITION DIAGNOSTIC SYSTEM FOR INTERNAL COMBUSTION ENGINE (ICE) AND METHOD OF OPERATING THE SAME

(71) Applicant: Federal-Mogul Ignition LLC, Northville, MI (US)

(72) Inventors: Stefano Papi, Modena (IT); Massimo A. Dalre, Modena (IT); Simone Daniele, Modena (IT); Federico Ricci, Terni (IT)

(21) Appl. No.: 19/277,716

(22) Filed: Jul. 23, 2025

Related U.S. Application Data
(60) Provisional application No. 63/674,614, filed on Jul. 23, 2024.

(51) Int. Cl. F02P 17/12

(52) U.S. Cl. CPC F02P 17/12

(57) ABSTRACT

An ignition diagnostic system and method for evaluating and optimizing the ignition performance of internal combustion engines (ICEs), such as those that burn hydrogen (H₂) and/or other fuels. According to one example, the ignition diagnostic system and method use an artificial intelligence (AI) model with one or more machine learning (ML) algorithm(s) to identify, predict and/or otherwise evaluate abnormal combustion events, and to provide such information to an electronic control unit (ECU) in real-time. The ECU, in turn, can make combustion-related modifications to one or more components of the ignition system to optimize performance. By integrating the AI model into the ignition diagnostic system and method, a fast and simplified solution is provided that can be implemented across a wide variety of ICEs, including those that burn alternative fuels, where detecting abnormal combustion events and monitoring combustion-related parameters can be important.

### FIELD

The present invention generally relates to ignition diagnostic systems and methods for internal combustion engines (ICEs) and, more particularly, to ignition diagnostic systems and methods that use artificial intelligence (AI) to evaluate and optimize different aspects of the combustion process.

### BACKGROUND

In order to decrease carbon emissions in the transportation sector and tackle air quality issues, regulations concerning pollutant and greenhouse gas emissions are pushing the advancement of cleaner and more efficient internal combustion engines (ICEs). To achieve sustainable mobility, it is essential to investigate modern combustion techniques, enhance the hybridization of vehicles, and encourage the use of renewable and alternative fuels.

In this context, hydrogen (H₂) has been identified as a promising alternative to fossil fuels, as it is capable of eliminating carbon, carbon monoxide, and carbon dioxide emissions, and enabling high efficiencies under very lean combustion conditions and thereby reducing NOx emissions as well. Hydrogen's wide flammability limits and rapid flame propagation ensure stable combustion, especially in lean mixtures. It can be used in internal combustion engines in dedicated fuel, bi-fuel, or dual-fuel configurations. Research promotes hydrogen as a sole fuel or additive to fossil fuels to improve brake thermal efficiency and reduce emissions. Hydrogen engines can tolerate higher compression ratios (e.g., up to 14.5:1) due to highly dilute mixtures and high auto-ignition temperatures, enhancing thermodynamic efficiency and potentially achieving significant engine efficiency. Using pure hydrogen nearly eliminates hydrocarbon (HC) and carbon monoxide (CO) emissions. While hydrogen addition reduces CO emissions, it can increase NOx emissions, which can be mitigated by water injection.

The transformation of ICEs to operate with hydrogen as an alternative fuel, while encouraging, is encountering myriad challenges. Numerous components necessitate adaptation and evolution to surmount existing issues and fulfill ambitious benchmarks. Among these components, ignition systems must undergo adaptation to address the increasingly demanding thermal, mechanical, and electrical challenges associated with this transition. When hydrogen is used with advanced strategies, conventional spark ignition systems sometimes struggle to maintain stable combustion processes under critical operating conditions. Moreover, despite the above-mentioned benefits, using hydrogen in ICEs poses some challenges, particularly with abnormal combustion events. These include preignitions, misfires with in-cylinder processes and backfires with port fuel injection (PFI) engines, which can trigger engine knock, causing damage to cylinders and pistons.

To mitigate these challenges, it can be desirable to prevent pre-ignition caused by ghost sparks or hot spots around the spark plug. This can be achieved by using a cooled ignition system or unconventional ignition methods, which not only prevent preignitions but can also facilitate the ignition of highly diluted hydrogen-air mixtures. This can be instrumental in avoiding or minimizing certain abnormal combustion events.

Some innovative ignition systems have been able to mitigate backfire phenomena in PFI engines that burn hydrogen by fast discharging residual energy trapped inside an ignition coil at the end of the spark. Moreover, the discharge configuration of the ignition system, along with the higher amount of energy released into the cylinder, can improve the engine power output compared to conventional spark ignition systems under the same operating conditions. This can be beneficial to preventing or reducing occurrences of certain abnormal combustion events.

However, abnormal combustion events can still arise and detecting them becomes an important task. While it is feasible to use internal pressure sensors to detect such events on a test bench, it is not always feasible to use such sensors on an actual vehicle, as these types of sensors can be costly and impractical. Hence, there is a need for innovative and advanced ignition diagnostic systems that enhance engine control strategies and optimize efficiency, particularly for hydrogen and other alternative fuel engines.

### SUMMARY

According to one embodiment, there is provided an ignition diagnostic method for use with an internal combustion engine (ICE), comprising the steps of: providing an artificial intelligence (AI) model utilizing at least one machine learning (ML) algorithm, the AI model is configured to correlate information from diagnostic signals with combustion-related parameters; receiving diagnostic signals from an ignition coil assembly that is associated with a cylinder in the ICE; obtaining information from the received diagnostic signals; inputting the obtained information into the AI model; using the AI model and the inputted information to predict combustion-related parameters for the cylinder; and using the predicted combustion-related parameters to determine if an abnormal combustion event has occurred in the cylinder.

In accordance with the various embodiments, the ignition diagnostic method may have any one or more of the following features, either singly or in any technically feasible combination:
the internal combustion engine (ICE) is a hydrogen (H₂) engine;
the providing step further comprises providing an artificial intelligence (AI) model that is configured to correlate information from diagnostic signals in the form of diagnostic signal lengths (Diag) with combustion-related parameters in the form of in-cylinder pressure values (P);
the diagnostic signal lengths (Diag) include information that is representative of both a charging phase of the ignition coil assembly and a discharging phase of the ignition coil assembly;
the information representative of a charging phase of the ignition coil assembly corresponds to an amount of time taken for a charging current to exceed a charging current threshold and is representative of a state or a condition of a primary winding in the ignition coil assembly;
the information representative of a discharging phase of the ignition coil assembly corresponds to an amount of time taken for a discharging current to fall below a discharging current threshold and is representative of a state or a condition of a secondary winding in the ignition coil assembly or of a corresponding spark plug;
the at least one machine learning (ML) algorithm predicts a maximum in-cylinder pressure (Pₘₐₓ), and the predicted maximum in-cylinder pressure (Pₘₐₓ) is used to determine if an abnormal combustion event has occurred in the cylinder;
the at least one machine learning (ML) algorithm predicts in-cylinder pressure trends (P_{cyl trend}), the predicted in-cylinder pressure trends (P_{cyl trend}) are used to compute a maximum in-cylinder pressure (Pₘₐₓ), and the computed maximum in-cylinder pressure (Pₘₐₓ) is used to determine if an abnormal combustion event has occurred;
the first using step further comprises using the AI model and the inputted information to predict a maximum in-cylinder pressure (Pₘₐₓ), and the second using step further comprises comparing the predicted maximum in-cylinder pressure (Pₘₐₓ) to a maximum cylinder pressure threshold to return a binary output, when the binary output is a certain value, the second using step determines that an abnormal combustion event has occurred in the cylinder;
the second using step further comprises comparing a predicted maximum in-cylinder pressure (Pₘₐₓ) to a maximum cylinder pressure threshold and, when the predicted maximum in-cylinder pressure (Pₘₐₓ) is less than the maximum cylinder pressure threshold, determining that an abnormal combustion event has occurred in the cylinder;
the method further comprises evaluating correlations between the diagnostic signals and one or more of the following parameter(s): voltage demand, spark advance, secondary current and/or primary current;
the artificial intelligence (AI) model includes a plurality of machine learning (ML) algorithms, and the output of each of the plurality of ML algorithms is weighted so that the method arrives at an overall determination if an abnormal combustion event has occurred in the cylinder; and/or
the ignition diagnostic method is part of a dual-method approach that combines a simplified analytical framework with a genetic algorithm (GA), the dual-method approach uses a diagnostic signal length (Diag) and one or more parameter(s) provided by an electronic control unit (ECU) to classify combustion events as regular combustion events or abnormal combustion events, and also provides an estimated maximum in-cylinder pressure (Pₘₐₓ).

According to another embodiment, there is provided an ignition diagnostic system for use with an internal combustion engine (ICE), comprising: an electronic storage device with an artificial intelligence (AI) model having at least one machine learning (ML) algorithm stored thereon, the AI model is configured to correlate information from diagnostic signals with combustion-related parameters; wherein the ignition diagnostic system is coupled to an ignition coil assembly that is associated with a cylinder in the ICE and is configured to: receive diagnostic signals from the ignition coil assembly; obtain information from the received diagnostic signals; input the obtained information into the AI model; use the AI model and the inputted information to predict combustion-related parameters for the cylinder; and use the predicted combustion-related parameters to determine if an abnormal combustion event has occurred in the cylinder.

In accordance with the various embodiments, the ignition diagnostic system may have any one or more of the following features, either singly or in any technically feasible combination:
the internal combustion engine (ICE) is a hydrogen (H₂) engine;
the at least one machine learning (ML) algorithm predicts a maximum in-cylinder pressure (Pₘₐₓ), and the predicted maximum in-cylinder pressure (Pₘₐₓ) is used to determine if an abnormal combustion event has occurred in the cylinder;
the at least one machine learning (ML) algorithm predicts in-cylinder pressure trends (P_{cyl trend}), the predicted in-cylinder pressure trends (P_{cyl trend}) are used to compute a maximum in-cylinder pressure (Pₘₐₓ), and the computed maximum in-cylinder pressure (Pₘₐₓ) is used to determine if an abnormal combustion event has occurred;
the at least one machine learning (ML) algorithm predicts a maximum in-cylinder pressure (Pₘₐₓ), compares the predicted maximum in-cylinder pressure (Pₘₐₓ) to a maximum cylinder pressure threshold to return a binary output, and when the binary output is a certain value, determines that an abnormal combustion event has occurred in the cylinder; and/or
the ignition diagnostic system is further configured to compare a predicted maximum in-cylinder pressure (Pₘₐₓ) to a maximum cylinder pressure threshold and, when the predicted maximum in-cylinder pressure (Pₘₐₓ) is less than the maximum cylinder pressure threshold, determine that an abnormal combustion event has occurred in the cylinder.

### DRAWINGS

Preferred embodiments will hereinafter be described in conjunction with the appended drawings, wherein like designations denote like elements, and wherein:

FIG. 1 is a schematic view of an ignition coil assembly that may be used with the ignition diagnostic system and method of the present application;

FIG. 2 is a graph showing waveforms of several signals, including a diagnostic signal provided by the ignition coil assembly of FIG. 1;

FIG. 3 is a photo and drawing of a spark plug that may be used with the ignition coil assembly of FIG. 1;

FIG. 4 is a photo of a test engine that may be used with the ignition diagnostic system and method of the present application;

FIG. 5 is a schematic illustration of a test engine setup that may be used with the ignition diagnostic system and method of the present application;

FIG. 6 is a graph showing waveforms of several signals, including in-cylinder pressure readings;

FIG. 7 is a graph showing waveforms of maximum in-cylinder pressure readings across a number of cycles;

FIG. 8 is a pair of graphs showing in-cylinder pressure readings, the graph on the left is for motored data where there is no active combustion and the graph on the right is for normal combustion data;

FIG. 9 is a graph generally corresponding to FIG. 7, except FIG. 9 shows the results of an analytical method that may be used to detect abnormal combustion events;

FIG. 10 is a schematic illustration of an artificial intelligence (AI) model that may be used with the ignition diagnostic system and method of the present application, the AI model utilizes three machine learning (ML) algorithms for predicting when an abnormal ignition event has occurred;

FIGS. 11-16 are graphs showing the accuracy of one of the potential machine learning (ML) algorithms of the AI model;

FIG. 17 is a graph generally corresponding to FIG. 7, except FIG. 17 shows the results of utilizing an AI model to detect abnormal combustion events;

FIGS. 18A-B are a series of graphs showing the results of utilizing an AI model to detect abnormal combustion events;

FIG. 19 is a series of graphs showing in-cylinder pressure readings and diagnostic signals, the graphs on top are for motored data where there is no active combustion and the graphs on bottom are for misfires;

FIG. 20 is a pair of graphs showing waveforms for several signals, the graph on the left shows diagnostic signals for each combustion cycle and the graph on the right shows the lengths of the diagnostic signals for each combustion cycle when sorted, longest to shortest;

FIG. 21 is a graph showing a waveform of in-cylinder pressure readings across a number of cycles;

FIG. 22 is a graph showing the probability results of the AI model;

FIG. 23 is a graph showing a waveform of in-cylinder pressure readings across a number of cycles;

FIG. 24 is a graph showing the probability results of the AI model;

FIG. 25 is a graph showing a waveform of in-cylinder pressure readings across a number of cycles;

FIG. 26 is a graph showing the probability results of the AI model; and

FIG. 27 is a schematic illustration of another embodiment of the ignition diagnostic system and method of the present application, where a dual-method approach combines a simplified analytical framework with an integrated AI model.

### DESCRIPTION

The present disclosure generally relates to ignition diagnostic systems and methods for evaluating and optimizing the ignition performance of internal combustion engines (ICEs), such as those that burn hydrogen (H₂) and/or other fuels. According to one example, the ignition diagnostic system and method use an artificial intelligence (AI) model to identify, predict and/or otherwise evaluate abnormal combustion events, and to provide such information to an electronic control unit (ECU) in real-time. The ECU, in turn, can make combustion-related modifications to one or more components of the ignition system to optimize performance. By integrating the AI model into the ignition diagnostic system and method, a fast and simplified solution is provided that can be implemented across a wide variety of ICEs, including those that burn alternative fuels (e.g., H₂, E-fuels and bio-fuels), where detecting abnormal combustion events and monitoring combustion-related parameters can be quite important. The combustion-related parameters can be evaluated in real-time on a cycle-by-cycle basis, can be evaluated on a cylinder-by-cylinder basis, and can be evaluated without the need for costly in-cylinder pressure sensors, such that combustion stability and performance are optimized.

The ignition diagnostic system and method described herein is generally designed for use with an ignition system having a separate ignition coil assembly for each cylinder, where each ignition coil assembly may include an ignition coil and a spark plug (e.g., a Hy2Fire® plug) and can be configured for use in a hydrogen-powered internal combustion engine. A non-limiting example of a suitable ignition coil assembly is described in U.S. application Ser. No. 18/650,422, filed on Apr. 30, 2024, the entire contents of which are hereby incorporated by reference in their entirety. The ignition diagnostic system and method identifies correlations between diagnostic signals, such as the “diagnostic signal” sent over the output terminal in the '422 application, and in-cylinder pressures in order to predict abnormal combustion events, like misfires, and help optimize combustion performance. The diagnostic signal may include information representative of both a charging phase and a discharging phase and, according to one non-limiting example, can be used in conjunction with a separate “trigger signal” to determine a charging duration (t₁−t₀) and/or a discharging duration (t₃−t₂). The charging duration generally corresponds to the amount of time it takes for a charging current flowing through a charging path that includes a primary winding to reach a charging current threshold, whereas the discharging duration generally corresponds to the amount of time it takes for a discharging current flowing through a discharging path that includes a secondary winding to fall below a discharging current threshold. The diagnostic signal can be provided to the ignition diagnostic system and method on a continuous basis in the form of a multiplexed digital diagnostic signal that includes information from an active charging signal provided by a charging evaluation circuit and information from an active discharging signal provided by a discharging evaluation circuit, where the multiplexed digital signal is sent over a single output terminal. Of course, other diagnostic and/or trigger signals may be used, as the ignition diagnostic system and method of the present disclosure is not limited to the particular signals of the '422 application. The present disclosure aims to establish a link between the behavior of diagnostic signals and the development of pressure within the combustion chamber. This correlation or link enhances the reliability and precision of diagnostic feedback pertaining to combustion performance and can do so without the use of costly pressure sensors in each cylinder.

In one example, an artificial intelligence (AI) model having one or more machine learning (ML) algorithm(s) that correlate information from diagnostic and/or trigger signals to combustion-related parameters, such as in-cylinder pressures, is first developed and trained during a training phase, and then the AI model is deployed and utilized during an operational phase to predict certain combustion-related parameters. During the training phase, which can be carried out on a test bench or in another controlled testing environment, a pressure sensor installed in each engine cylinder provides actual pressure readings to the ignition diagnostic system and method. At the same time, an ignition coil assembly for each cylinder provides a diagnostic signal (like those mentioned above) that is representative of charging and discharging phases, while an ECU provides a trigger signal. By having the actual pressure readings for each cylinder, as well as the corresponding diagnostic/trigger signals, the ignition diagnostic system and method are used to train the AI model, including its one or more ML algorithms. This training may be carried out over all engine conditions. Once the AI model is properly trained, it can be deployed in actual ignition systems to accurately predict in-cylinder pressures for each cylinder of the engine on a continuous or cycle-by-cycle basis, without using costly pressure sensors. In this way, the AI model functions as “virtual pressure sensors” of sorts, where it mimics the behavior of actual pressure sensors while only using the information from diagnostic/trigger signals.

The correlation achieved between diagnostic signal behavior and combustion-related parameters (namely, in-cylinder pressures) can be used to realize cycle-by-cycle predictions of the combustion process, and to optimize the ignition system driving strategy of the ECU. The prediction accuracy can be improved by a driving strategy of the ignition coil which includes the acquisition of the diagnostic signal during one or more additional ignition coil activations before and after a main firing. The elapsed time between the main firing and a first re-activation can spread between 50 μs to 10 ms, for example, and in the same time range can be the following ignition coil's re-activations. Dwell time of the coils during the restrike can have a different set up compared to main ignition dwell time. Correlation between diagnostic signals from the main ignition spark and secondary detecting spark (can be one or more) through the implemented algorithms can give a detailed feedback on phenomena that is pressure related (e.g., misfire, backfire, knocking, good combustion etc.). Other embodiments are certainly possible.

Previous investigations may have identified correlations between diagnostic signals and in-cylinder pressures. However, due to the challenges in analytically determining this correlation directly, alternative instruments were necessary. Harnessing the potential of artificial intelligence (AI) presents a promising avenue, as it offers the capability to extract intricate patterns and relationships from complex datasets, which traditional analytical methods may struggle to discern. By applying machine learning and/or deep learning algorithms to the diagnostic signals and corresponding in-cylinder pressure data, it becomes possible to uncover slight correlations and enhance the understanding of combustion dynamics in internal combustion engines. The ignition diagnostic system and method not only facilitate more accurate diagnostic feedback but also pave the way for future advancements in optimizing ignition strategies and improving overall engine performance.

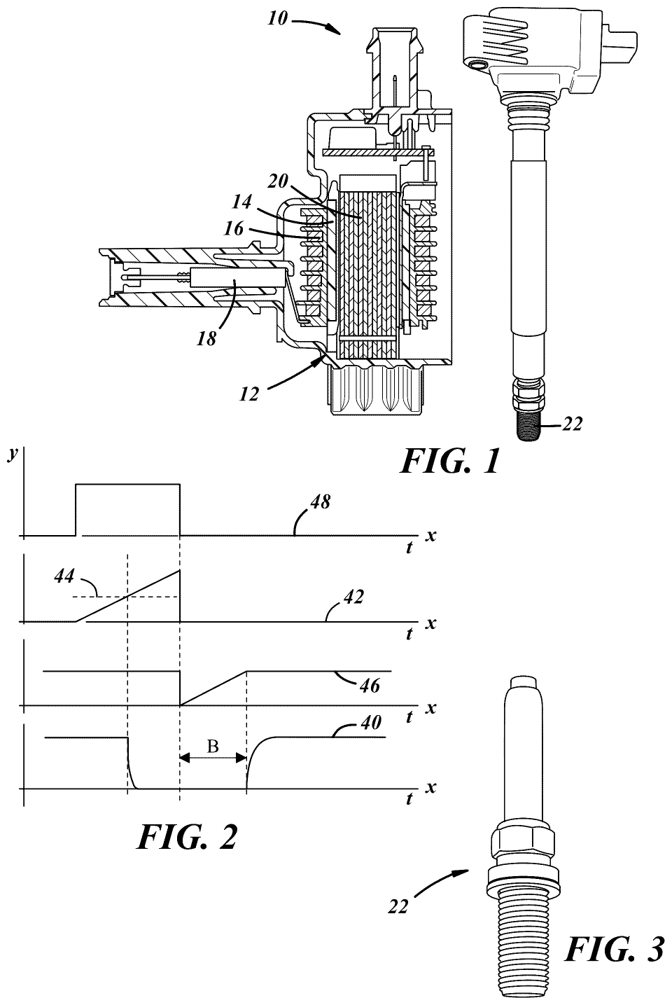

All tests described herein were conducted using an inductive spark ignition coil assembly supplied by the Applicant, known as the Hy2Fire® ignition system, as shown in FIG. 1. This ignition coil assembly 10 may include a power circuit with a high voltage transformer 12 (14V to 40 kV) and an ignition insulated gate bipolar transistor (IGBT) on a primary side 14. A diode on a secondary side 16 prevents pre-ignition by avoiding positive current during transformer charging, and a suppressor 18 limits EMI. The internal magnetic core 20 can store up to 90 mJ of energy, for example. Designed for hydrogen engine applications, this device can discharge residual energy in the transformer's secondary side and measure both primary and secondary currents in the transformer windings 14, 16. The ‘energy dumper’ feature protects against pre-ignition, while the ‘diagnostic’ feature generates a signal to detect abnormal behavior. The ignition coil assembly 10 shown in FIG. 1 largely coincides with that of the '422 application, which has been incorporated herein by reference.

The diagnostic signal 40 activates when the primary side charging current (coil current) 42 exceeds a charging current threshold 44 and deactivates when the secondary side discharging current (spark current) 46 drops below a discharging current threshold (e.g., drops to zero), see FIG. 2. The ECU uses this diagnostic signal 40, in conjunction with a trigger or ignition timing signal 48 which it generates, to calculate the elapsed time between the certain rise and fall edges, helping to identify issues like open or short circuits and ensure proper coil charging. The time between the certain fall and rise edges informs the ECU about the discharging duration, indicating possible issues like secondary short circuits, spark plug wear, liquid in the gap, and combustion quality. For a more detailed discussion of these signals and the information they provide, please see the '422 application. The ECU may include a suitable electronic storage device (e.g., non-volatile memory, flash memory, EEPROM, etc.) for storing or maintaining the AI model, the ML algorithms and/or the electronic instructions for carrying out the ignition diagnostic method of the present application. It is possible for the ignition diagnostic system of the present application to be part of the ignition coil assembly 10, the ECU or some other suitable component or device, as the present system and method are not limited to any specific configuration. Additionally, it may check for backfires caused by unwanted sparks. The ignition coil assembly 10 includes a spark plug 22, such as a suitable M12 cold spark plug (e.g., a REA23065D-WB plug, see FIG. 3), which is specifically designed for hydrogen ICE applications. This spark plug features a 0.5 mm gap between the central electrode and two radial ground electrodes. This design was chosen for several reasons, however, it should be appreciated that any suitable spark plug could be used and the present ignition diagnostic method and system are not limited to any particular spark plug:
The low temperature of the electrodes and insulator reduces the risk of preignition or abnormal combustion due to hot-spot ignition of hydrogen.
The smaller spark gap (0.5 mm compared to the typical 0.8 mm used with conventional fuels for this engine type) reduces the high ignition voltage that would otherwise be necessary.
The spark gap's visibility from below the plug makes it ideal for optical investigations of the spark and early flame development.

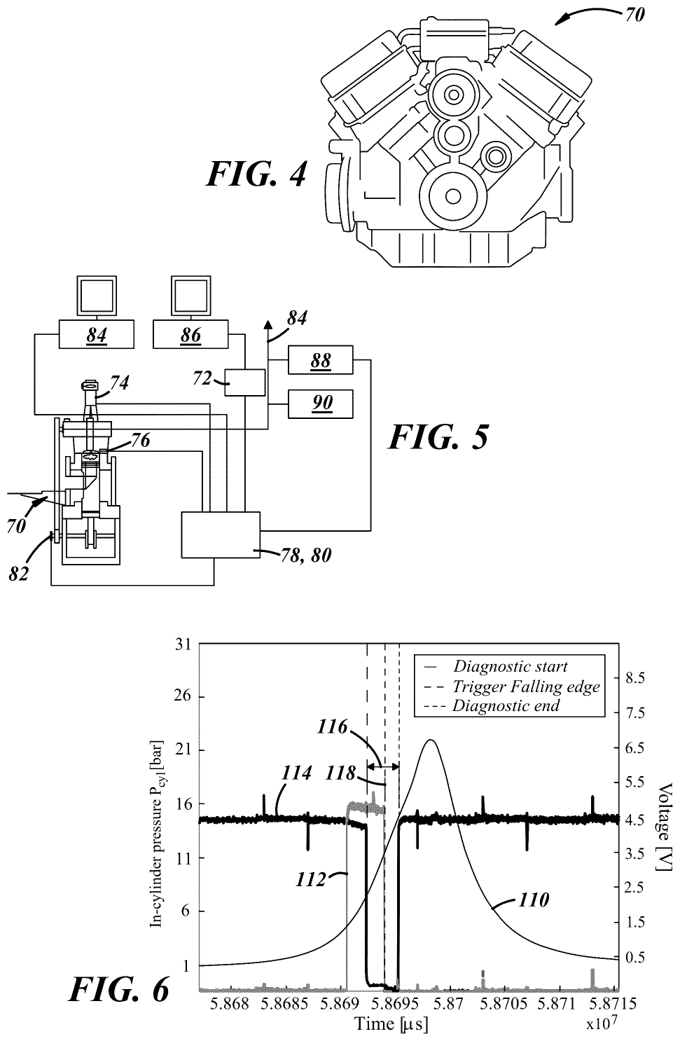

Measurements were performed on a 500-cc single-cylinder engine 70 (FIGS. 4-5) with four valves, a pent-roof combustion chamber, and a reverse tumble intake port system for DI and PFI modes (details in Table 1). Tests at 1000 rpm in PFI mode used centrally located igniters. Airflow was controlled by a fixed throttle valve upstream of the intake manifold to maintain consistent airflow and in-cylinder charge motion. The air-fuel ratio was managed by adjusting the hydrogen fuel quantity at 4 bar absolute pressure. A research ECU 72 (e.g., Athena GET HPUH4) controlled injector energizing time and ignition timing. Intake port pressure was measured with a piezoresistive transducer 74 (e.g., Kistler 4075A5), and in-cylinder pressure with a piezoelectric transducer 76 (e.g., Kistler 6061 B). A HIOKI MR6000 oscilloscope 78 captured real-time pressure signals, ECU ignition signals, igniter diagnostics, and O₂ % concentration. A combustion analysis system (e.g., Kistler KIBOX) 80 with 0.1 CAD resolution also recorded these signals. The test engine setup in FIG. 5 may also include a diagnostic computer 84, an ECU computer 86, an O₂ % sensor 88, a raw gas analyzer 90, as well as other devices and components known in the art. The oscilloscope 78 provided time-resolved data, while the combustion analysis system 80 provided CAD-resolved data using an optical encoder 82 (e.g., AVL 365C). The A value was adjusted in real-time based on O₂ % concentration (Equation 1).

$$λ = \frac{( 1 + {x}_{{O}_{2}} )}{( 1 - \frac{{x}_{{O}_{2}}}{{y}_{{O}_{2}}} )} \qquad ( 1 )$$

where x_{O2} and y_{O2} are the wet concentrations of oxygen in the exhaust gas 84 and intake air respectively.

TABLE 1
Engine data
Feature, Value and Unit

Displaced volume 500 cc
Stroke 88 mm
Bore 85 mm
Connecting rod length 139 mm
Compression ratio 8.8:1
Number of valves 4
Exhaust valve open 13 CAD bBDC
Exhaust valve close 25 CAD aBDC
Intake valve open 20 CAD bBDC
Intake valve close 24 CAD aBDC

The following signals, which are gathered by the oscilloscope 78 during the training phase (see FIG. 6), have been utilized by the proposed Machine Learning (ML) algorithms to determine the combustion quality of each cycle:
In-cylinder pressure (P_{cyl}) 110
ECU trigger signals 112, used to determine the ignition timing (IT).
Diagnostic signals 114, with their lengths (Diag) 116 estimated.

The ignition timing (17) 118 and diagnostic signals (Diag) 116 are initially computed based on time but may be subsequently converted to crank angle degrees (CAD) according to the engine's operating speed.

This section provides a comprehensive description of the analytical methodology employed by the ignition diagnostic system and method to detect misfire events. It explores the limitations or challenges of the current analytical approach and presents reasons why alternative methods may be needed to address these issues.

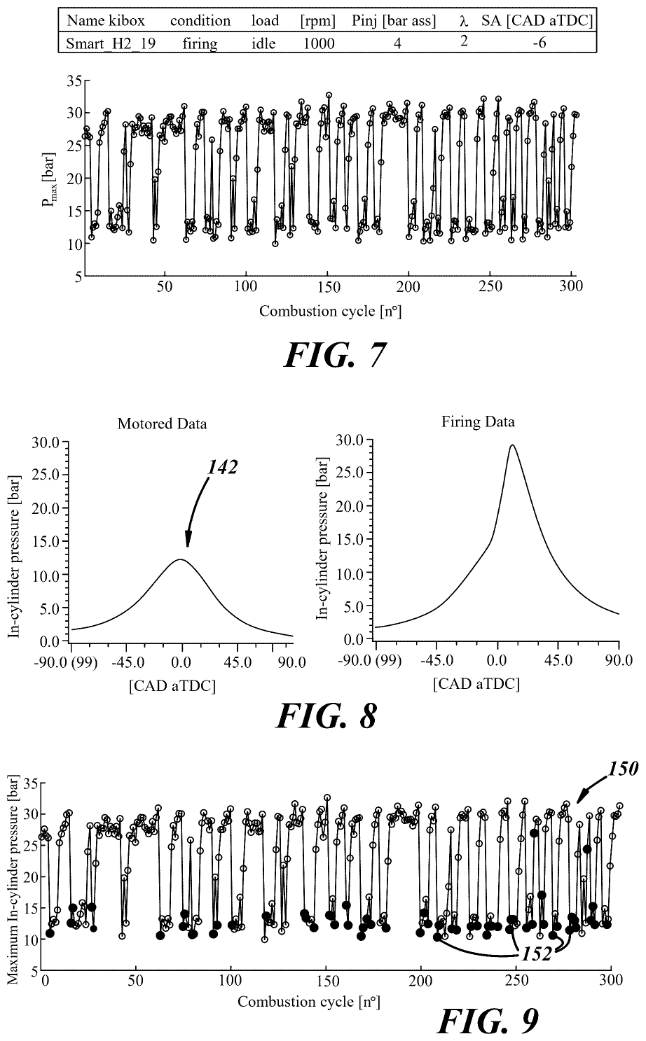

Turning to FIG. 7, there are shown combustion-related parameters in the form of a distribution of maximum in-cylinder pressure readings 140. A first step determines a pressure threshold for misfire individuation using the following Equation 2:

$${P}_{max , Threshold} = 1.4 \times {P}_{max , Motored} \qquad ( 2 )$$

with P_{max,Motored}=13 [bar], see 142, FIG. 8. (in-cylinder pressure trends with motored data on the left and firing data on the right). “Motored” data refers to combustion-related parameters or operating conditions that occur when there is no active combustion. Motored data is recorded when the ICE is being turned by an external force, like an electric motor or dynamometer, without any fuel actually being injected and ignited in the cylinder. In the present case, motored data is used to determine a pressure threshold 142 for misfires or other abnormal combustion events (Equation 2 above). However, it is also preferable for the AI model to be trained using datasets that include both normal combustion data and motored data, as the motored data resembles misfires or other abnormal combustion events where there is no active combustion. During the training phase, such events can be rare, or even absent altogether, which makes it preferable to include motored data during training of the AI model so that it can more accurately recognize and identify abnormal combustion events when they occur.

The following analytical method may be used to detect misfires and other abnormal combustion events. According to one example, the analytical method is based on the diagnostic length Diag 116 (determined using the diagnostic and trigger signals) of each combustion cycle.
1. With the engine firing, the Diag lengths for the first 10 cycles (i=10) are determined (the method could, of course, use a different number of cycles, such as 5, 20, 25 or 50).
2. The mean (mean firing) and standard deviation (std_firing) of these Diag lengths are calculated.
3. If the standard deviation falls below a threshold value, the method continues; otherwise, the operating point is deemed unstable (Equation 3).

$$Threshold = mean\_firing \times ( k \times std\_firing ) \qquad ( 3 )$$

4. Proceed to cycle i+1 (i+1=11) and update the moving parameters, namely the updated mean (mean_firing) and standard deviation (std_firing), until condition i+x1 (with x1>11) is met (Equation 4).

$$Diag ( i ) < Threshold \qquad ( 4 )$$

5. If the above condition is not met, cycle i+x1 is identified as a misfire event, and the moving average and standard deviation calculated up to event i+x1−1 will be frozen until a combustion event with a Diag length below the threshold value occurs.
6. When this happens, the diagnostic of cycle i+x1+x2 will be considered to update the moving average and standard deviation of stable combustion cycles, and so on.

FIG. 9 presents the results 150 of this method. The black circles 152 indicate events where the diagnostic signal analysis, based on the reported methodology, identified the event as a misfire. The method demonstrates an accuracy of approximately 47% in detecting misfire events. In this non-limiting example, there were 115 misfires with 54 misfires detected for a misfire detection accuracy of about 47%.

The analytical method tends to underestimate misfire events and often detects regular combustion events as misfires. Given the large dispersion in the analyzed case, the ignition diagnostic system and method of the present application shows good accuracy. The challenge for each operating condition lies in finding the correct threshold each time, or rather, the appropriate value of k that multiplies the moving standard deviation. Other tests have shown the same limitations, making it difficult to extend this methodology across an operational plane of m×n×z (m=rpm; n=load; z=lambda). Therefore, it is necessary to resort to an advanced tool such as an artificial intelligence (AI) model that utilizes Machine Learning (ML).

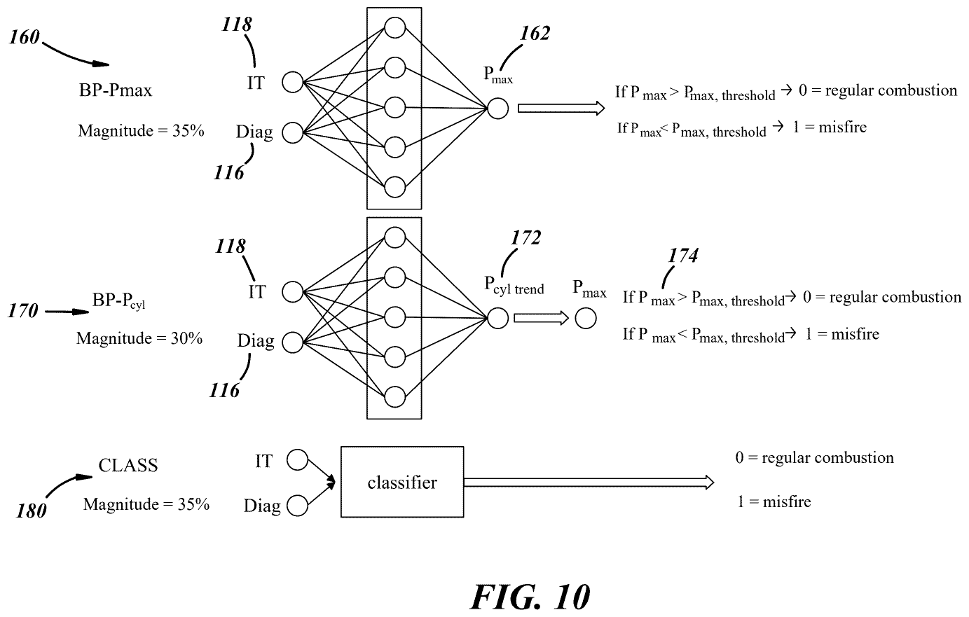

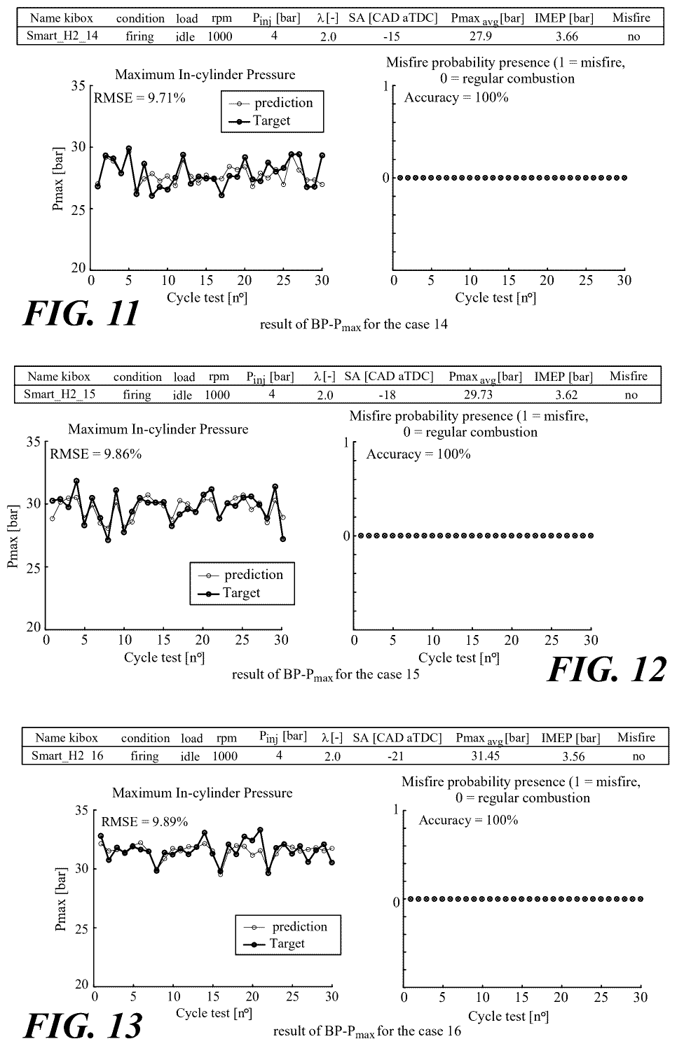

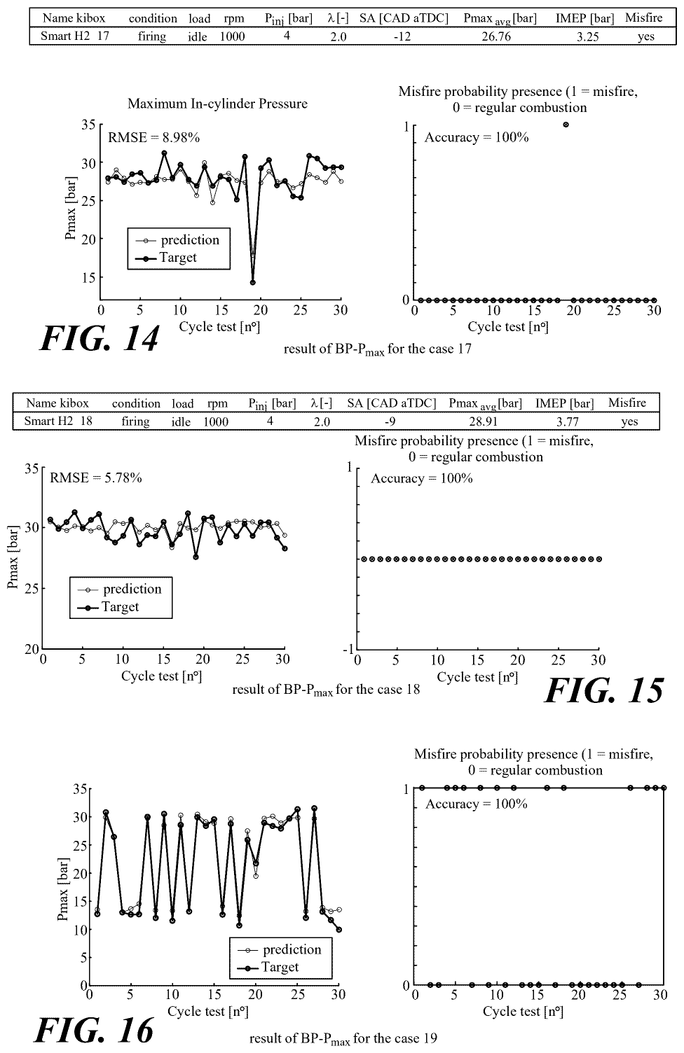

Turning now to FIG. 10, there is shown an example of an AI model having three distinct ML algorithms that have been developed to differentiate or identify abnormal combustion events, like misfires, from regular combustion cycles. FIG. 10 schematically illustrates a method of using the AI model during an operational phase to predict the combustion quality. The first ML algorithm 160, referred to as BP-Pₘₐₓ, uses the ignition timing (IT) 118 and diagnostic signals (Diag) 116 as inputs to predict the maximum in-cylinder pressure Pₘₐₓ 162. This predicted value is then classified according to Equation (2) to determine whether the event is a misfire or a regular combustion.

The second ML algorithm 170, referred to as BP-P_{cyl}, uses the ignition timing (IT) 118 and diagnostic signals (Diag) 116 as inputs to predict entire in-cylinder pressure traces 172 (not just the maximum in-cylinder pressure). From the predicted traces 172, the algorithm then computes the Pₘₐₓ 174 and classifies it according to Equation (2) to determine whether the event is a misfire or a regular combustion.

The third ML algorithm 180, referred to as DI, uses the ignition timing (IT) 118 and diagnostic signals (Diag) 116 as inputs to catalogue the combustion event as regular combustion (prediction=1) or as an abnormal combustion event (prediction=0), according to the Equation (2). For any of the ML algorithms disclosed herein, the algorithm may output or assign a value for the combustion-related parameter (e.g., an in-cylinder pressure) by the forward propagation of the input through the layers of the trained artificial neural network (ANN), as opposed to simply being calculated or extrapolated by a simple equation.

A specific magnitude or weight may be assigned to each ML algorithm based on preliminary investigations and is used to determine the probability of a misfire event. FIG. 10 resumes the ML methodology for misfire prediction.

According to another embodiment, a dual-method approach has been developed, combining a simplified analytical framework with an integrated AI model to identify combustion characteristics, such as misfire events and maximum in-cylinder pressure. The method has been tested across varying operating conditions, by varying IT, engine speed (SPEED) and throttle valve position (TVO). This embodiment provides a simple and user-friendly system for implementation in an ICEs' ECU. However, ease of integration can sometimes come at the cost of lower levels of accuracy, when compared to more complex models.

This embodiment may rely exclusively on the diagnostic signal length acquired from the ignition coil assembly and aims to establish a misfire detection methodology across varying operating conditions. To facilitate consistent identification across varying operating conditions, the detection threshold is established during a dedicated initialization phase for each operating point (e.g., the first 20 engine cycles), under confirmed firing conditions. The procedure may involve the following steps: Primary Threshold Estimation: The average value of the diagnostic signal duration across these 20 cycles is calculated and defined as the reference threshold; Signal Dispersion Analysis: The standard deviation of the diagnostic signal duration during this interval is evaluated to quantify its variability; and Definition of Multilevel Thresholds: Using the mean and standard deviation, four thresholds are constructed to delineate discrete probabilistic intervals associated with increasing likelihoods of misfire occurrence. The classification scheme may be as follows: 0.00—No probability of misfire; 0.50—Low probability of misfire; 0.75—High probability of misfire; 1.00—Full probability of misfire.

To enhance diagnostic reliability, additional logic may be implemented to suppress transient artifacts and false detections. Non-limiting examples of such logic include: Removal of Isolated Spikes: If a probability value is below 0.5 and immediately preceded by a value equal to or exceeding 0.5, both values are reset to zero. This eliminates sporadic, non-recurring fluctuations. Removal of False Misfires: If the current value and the two preceding values are below 0.5, but the third preceding value is equal to or greater than 0.75, all four are reset to zero. This targets false positives induced by short-term instabilities. Identification of Misfire Zones: When two consecutive data points exhibit a probability equal to or greater than 0.5, a misfire zone is identified. To account for post-misfire transient behavior, during which diagnostic stability is compromised, and the measured Pₘₐₓ converges to the motored pressure level, the probability is set to 1 for an additional interval of uncertainty Range cycles. Other examples of logic for filtering out transient readings and false detections may be employed as well.

A dedicated AI model may be implemented for each operating point to identify key combustion features, such as the maximum in-cylinder pressure (Pₘₐₓ). The AI model can be trained exclusively on firing events, with motored cases intentionally excluded from the training dataset. To facilitate future implementation, Pₘₐₓ is modeled as a linear function of the input variables, namely diagnostic signals, engine speed, throttle valve opening, and ignition timing. Once combustion stability is confirmed by means of analytic method, a Genetic Algorithm (GA) can be employed for a number of consecutive combustion events (e.g., 70) for each operating point, yielding a distinct equation corresponding to each specific parameter combination. As a result, the number of generated equations is directly proportional to the number of operating points evaluated. For operating points not explicitly included in the dataset, a linearization approach, consistent with standard ECU calibration practices can be applied to estimate the corresponding equation.

The analytical model may serve as a preliminary validation step for misfire-free operation. Once combustion stability is confirmed, the AI model, trained over the initial 70 firing combustion cycles, is employed to predict the maximum in-cylinder pressure. In the presence of a detected misfire, the predicted Pₘₐₓ value is overridden and set to the minimum pressure observed under motored conditions, acknowledging the physical equivalence between misfire and motored behavior.

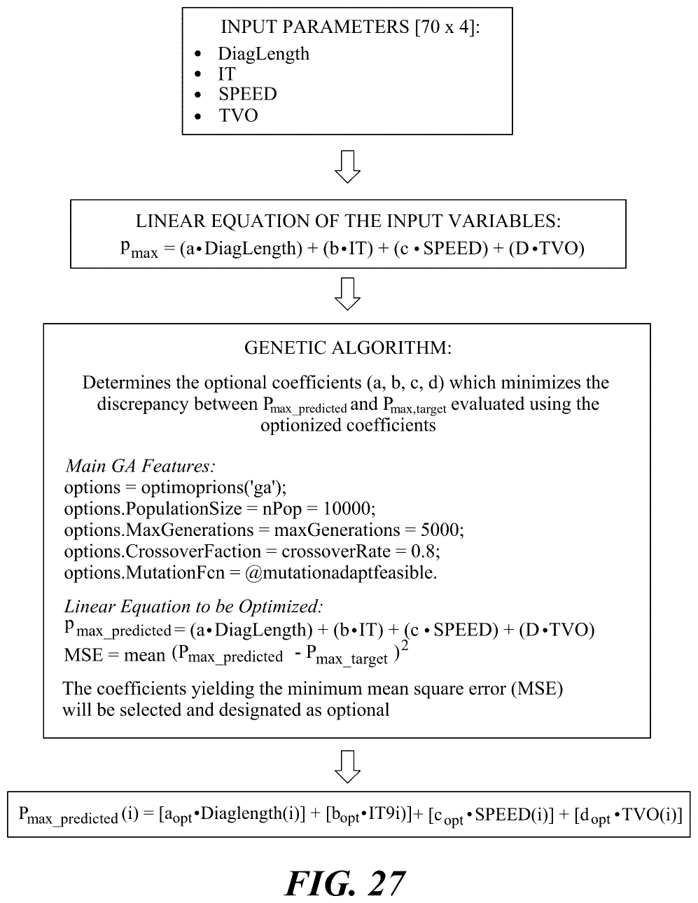

It is worth noting, in the absence of sufficient training data for data-driven modeling, a reduced version of the methodology, hereinafter referred to as the simple misfire model, could be employed. This variant relies exclusively on the diagnostic signal length recorded during confirmed firing operation to detect misfire events. A non-limiting example of how this embodiment may be implemented is schematically illustrated in FIG. 27.

In this section, findings from various analytical methods and Machine Learning (ML) models are discussed and applied to distinguish abnormal combustion events from regular combustion processes. Starting with the results obtained from the BP-Pₘₐₓ methodology 160, which utilizes the IT and diagnostic Diag signals as inputs to predict the maximum in-cylinder pressure. Following this, the results from three combined ML structures designed to enhance the accuracy and reliability of misfire detection are discussed. These results offer insights into the effectiveness of each method and highlight the potential of advanced diagnostic tools for improving combustion analysis in hydrogen-fueled internal combustion engines.

### Results for BP-Pmax

Firstly, the performance of BP-Pmax 160 was evaluated on a case-by-case basis to determine the feasibility of the proposed machine learning methodology. Additionally, cases with an increasing number of misfires were analyzed to effectively investigate the behavior of the structure under progressively critical operating conditions. It is worth highlighting that:
Each analyzed case may include 305 consecutive cycles.
90% of the dataset is allocated for training and validating the AI model.
The remaining 10%, which the architectures have never encountered before, may be reserved for testing and prediction purposes.
The AI's output is compared to the known target values (clearly defined by the user) to assess the algorithm's performance, by considering the Root Mean Square Error (RMSE) on the normalized data (Equation 5):

$$RMSE = \sqrt{\sum {( ypredicted - ytarget )}^{2} ) / n )} \qquad ( 5 )$$

where n is the number of samples or instances in the dataset test.

FIGS. 11-18 show the capability of BP-Pmax 160 to reproduce the target maximum in-cylinder pressure. In all cases analyzed, the Root Mean Square Error consistently remains below 10%, indicating the accuracy of our predictive models in estimating target values compared to actual outcomes. Moreover, the methodology outlined above achieves a classification accuracy of 100% in distinguishing between misfires and normal combustion events during the test cycles analyzed for combustion. During the training phase, misfire events were presented to the AI algorithm, however, these events did not appear in the test dataset. The AI algorithm's ability to accurately identify and handle such discrepancies can be crucial for its performance.

Based on the obtained results, the analysis can be continued by considering the same operating points previously analyzed but now incorporating four different possible targets and the three AI structures described herein.

In this paragraph, four possible targets are hypothesized, similar to real-world applications. The performance of three algorithms is evaluated in determining the percentage probability of misfire presence. This assessment provides insight into the accuracy and reliability of each algorithm when applied to practical scenarios. The results demonstrate how well each ML algorithm can predict misfire probabilities, reflecting their potential effectiveness in real applications.

Target 1—Known Case with Misfire Events

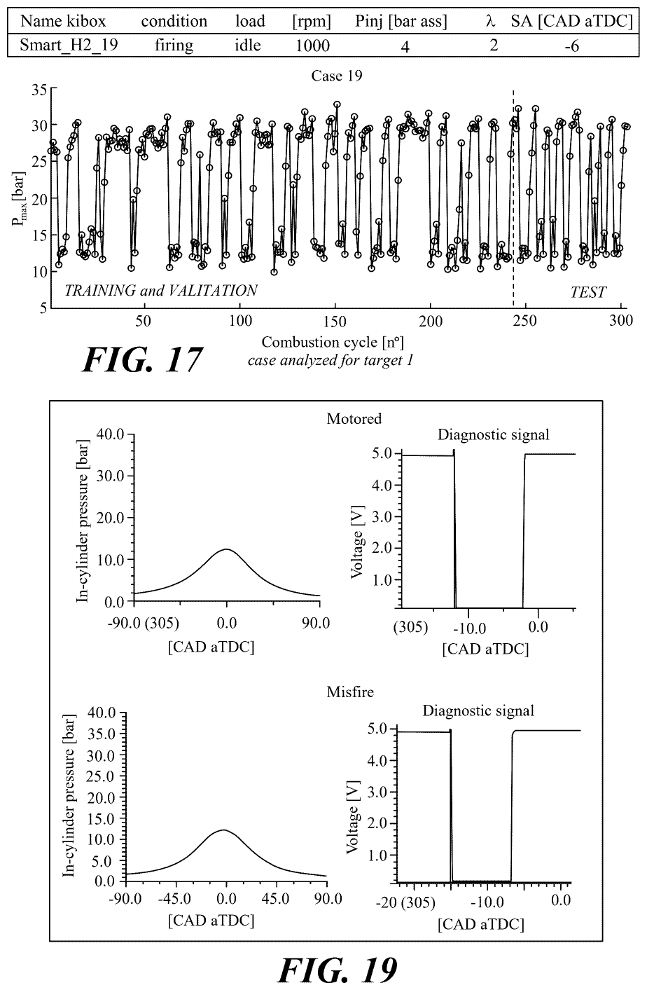

There is an interest in identifying real-time potential misfire events for a specific operational case that is already known. It is assumed that misfires have already been observed for that operational point (see FIG. 17).

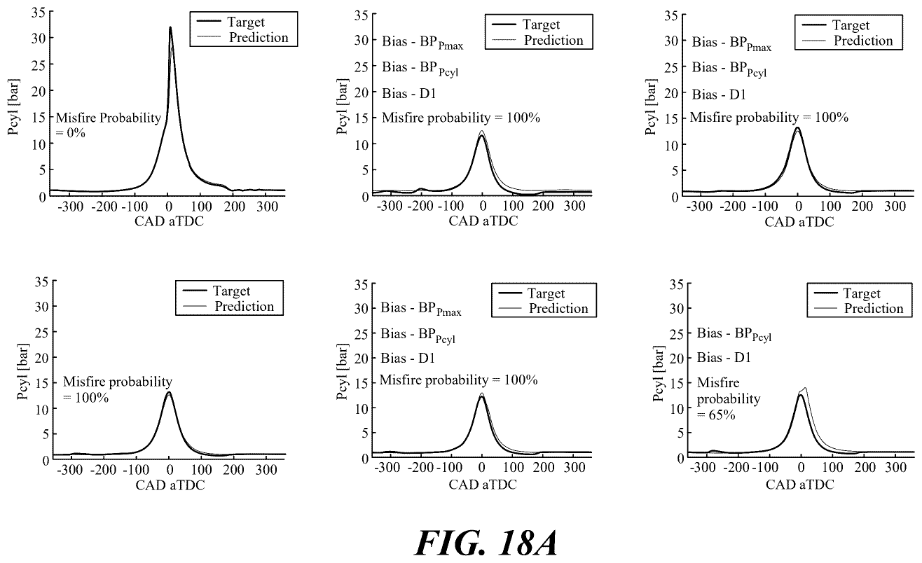

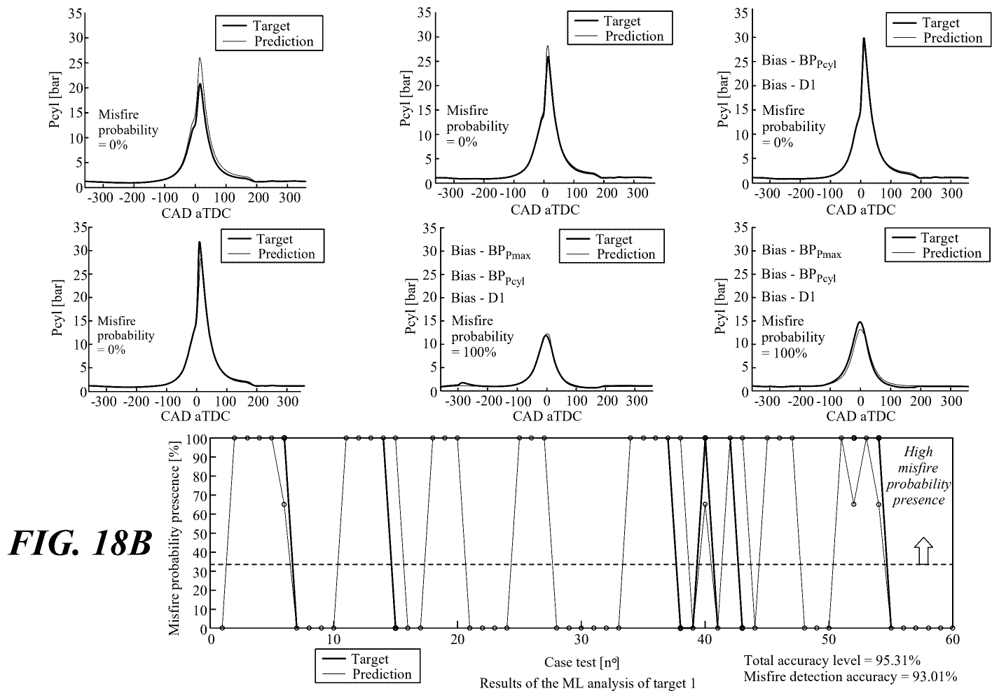

The results of the analysis are presented in FIG. 18. The figure includes examples of in-cylinder pressure predictions, with the predictions shown in red and the target values in black.

Additionally, it displays the percentage of misfires. A comparison plot is also included, illustrating the prediction versus the target in terms of misfire identification, along with the corresponding global accuracy level. A critical threshold for accurate misfire identification has been established at a 35% probability of misfire presence.

The proposed method demonstrates an overall accuracy of approximately 95% and exhibits a 93% accuracy in detecting misfire events. This indicates that the method is highly effective at identifying misfires, with a strong capability to distinguish between normal and misfire conditions. The high accuracy rates suggest the robustness of the approach, making it a reliable tool for real-time misfire detection in various operational scenarios.

Target 2—Known Case with No Previous Misfire Event

There is an interest in identifying real-time potential misfire events for a specific operational case that is already known. It is assumed that misfires have not yet been observed for that operational point.

In this case, unlike in Target 1, the motored parameters are necessary because the provided dataset does not contain misfire events. In fact, it is assumed that in the event of a misfire, the diagnostic signals exhibit the same behavior as a motored case under the same operating conditions, see FIG. 19.

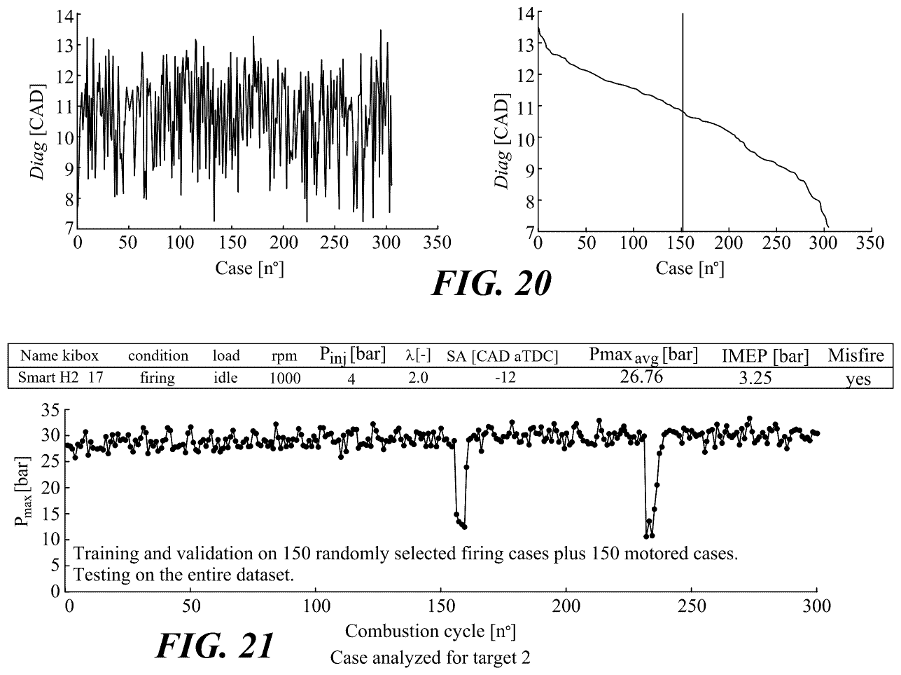

In the current dataset, only regular combustion events are considered for the analyzed case, and 150 of these events are randomly selected. Following the method for selecting motored cases described in FIG. 20, 150 motored cases are added to the 150 firing cases for training. In FIG. 20 (left), there is shown a diagnostic trend for each combustion case of target n.2 and (right) sorted from longest to shortest Diag. The left area represents the lengths used to train the AI, substituting for the length of misfire events.

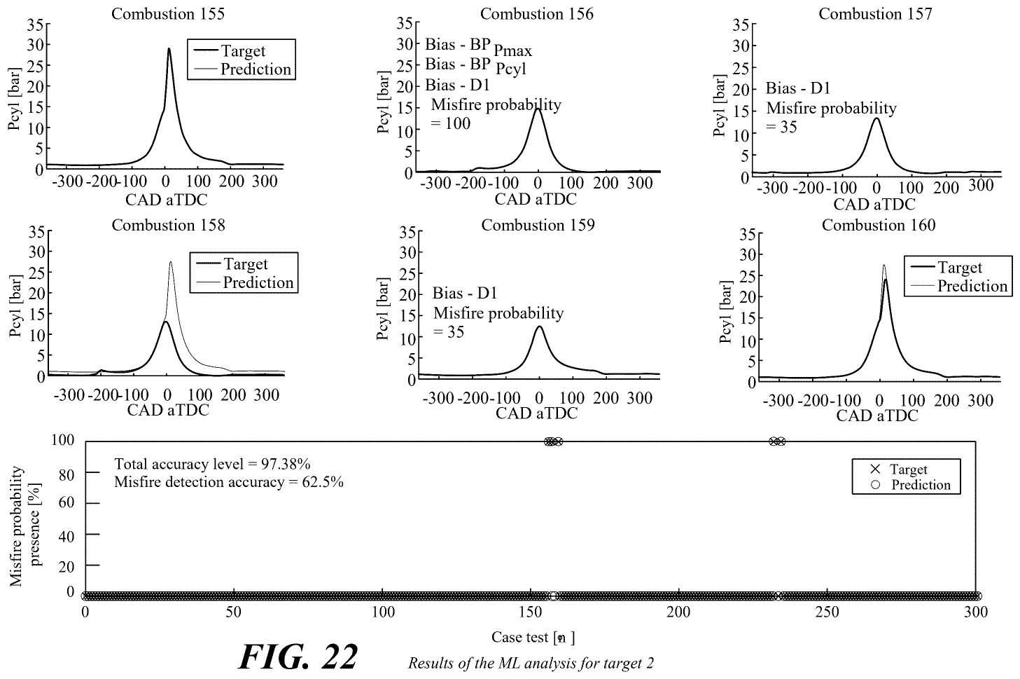

The test will then be conducted on the entire spectrum available (FIG. 21) to simulate real-time acquisition and verify if the proposed method can identify misfire events despite never having encountered them before (results in FIG. 22). For this case, it was decided not to plot the predicted in-cylinder pressure when the misfire probability exceeded 35%. FIG. 21 represents training and validation on 150 randomly selected firing cases plus 150 motored cases, with testing on the entire dataset.

The proposed method demonstrates an overall accuracy of approximately 98% and a misfire detection accuracy of about 63% (5 out of 8 misfire events correctly detected). Isolated misfire events are detected with 100% accuracy. Additionally, the method accurately identifies misfire zones. When multiple consecutive misfires occur, the artificial neural network (ANN) may struggle to recognize the continuity but can determine the beginning (156) and end (159) of the misfire zone marked by consecutive anomalous events. This behavior is attributed (as observed in combustion analysis system data) to the intrinsic behavior of the first stroke diagnostics, which tend to show lengths comparable to regular combustion in the case of internal misfire events within a misfire zone. In other words, the ANN identifies the first and last misfire within a consecutive series and may not detect some within this range. This deficit is not attributable to the ANN but rather to the inherent behavior of the diagnostics on which the networks are trained.

### Target 3—Predicting Case Inside a Known Operating Range (Interpolation)

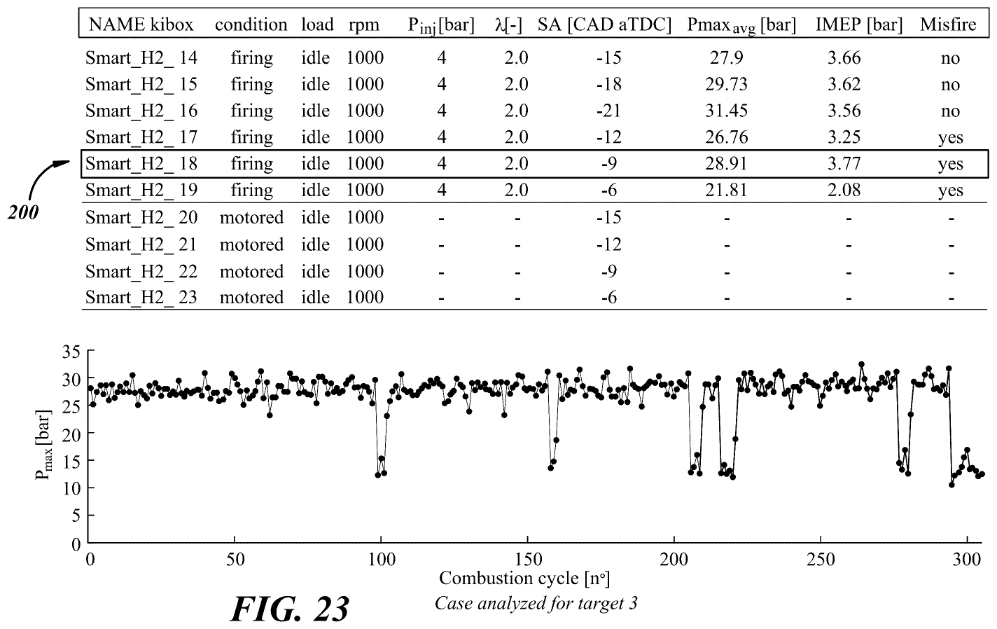

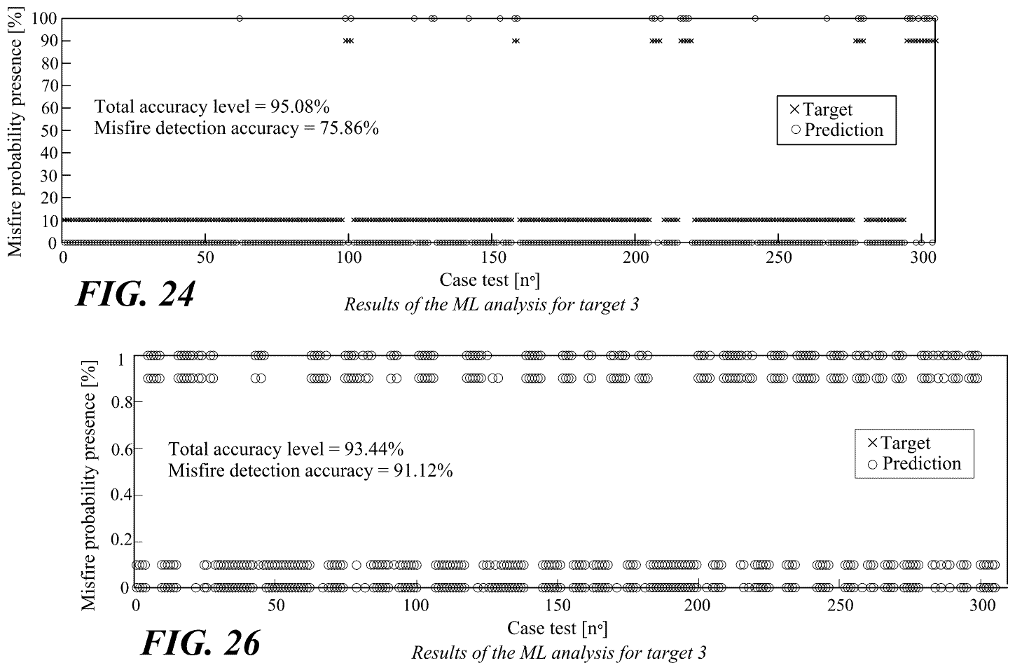

The objective is to identify misfire events within a known operational range for unexplored operating points, line 200 in FIG. 23. It is assumed that no tests have been conducted on the specific operating point in question. This point is within the known operational range. The request is for pressure traces of known operating points and the corresponding motored traces. Additionally, the motored trace for the unexplored operating point is required. Due to the high amount of data required for the training, for this request, the focus is exclusively on the ability of D1 to distinguish between regular events and misfires.

The results demonstrate the classification network's ability to identify misfire zones within the test range with an accuracy of 22 correctly identified cases out of 29. The deficit is consistently associated with ‘internal’ misfire events within a specific misfire range. However, the algorithm is capable of detecting isolated misfires and ‘zones’ of misfire where multiple anomalous events occur in succession.

### Target 4—Predicting Case Outside a Known Operating Range (Extrapolation)

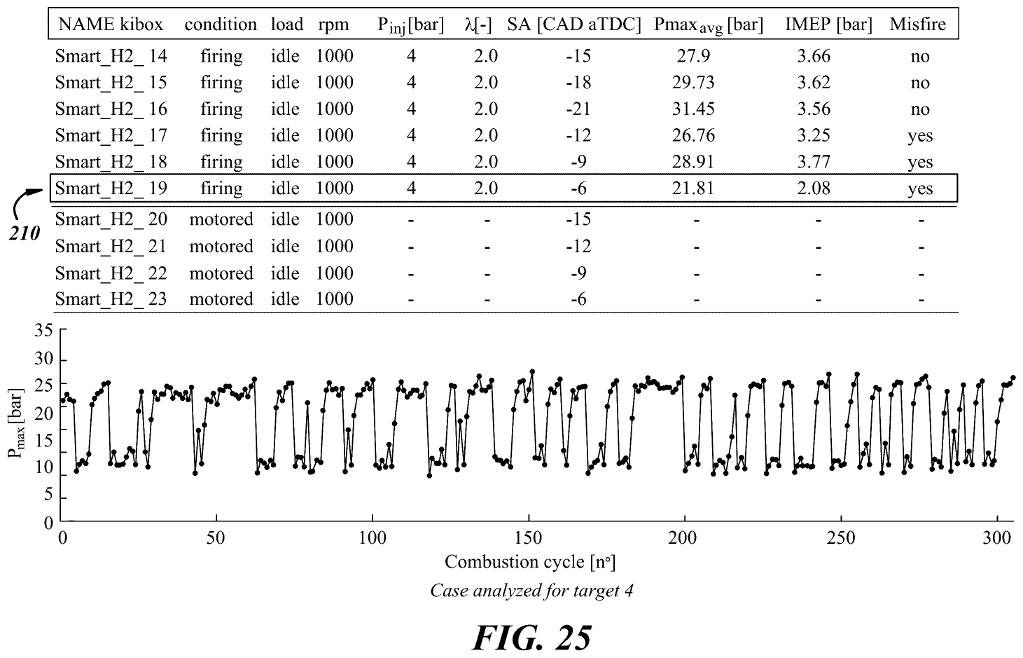

The objective is to identify potential misfire events in real-time for a specific unknown operational scenario, line 210 in FIG. 25. No previous tests have been conducted at this particular operational point, which is beyond the known operational range. We need pressure traces from known operational points, both during firing and motored conditions. Additionally, we require motored condition data for the unknown operational scenario we intend to investigate. Due to the high amount of data required for the training, for this request, the focus is exclusively on the ability of II to distinguish between regular events and misfires (results in FIG. 25).

With an accuracy exceeding 90%, one is able to predict misfire events for an operational case that falls outside of a known operating range.

Based on the comprehensive analysis and results presented herein, several conclusions can be drawn regarding the application of analytical methods and Machine Learning algorithms for detecting abnormal combustion events, specifically misfire events, in hydrogen-fueled internal combustion engines:

Effectiveness of BP-max Methodology: The BP-Pmax method, utilizing IT and diagnostic signals to predict maximum in-cylinder pressure, consistently demonstrated robust performance. With a Root Mean Square Error (RMSE) consistently below 10%, it proved accurate in estimating target values. Furthermore, achieving 100% classification accuracy in distinguishing between misfires and normal combustion events underscores its reliability under various operational conditions.

Performance of Combined ML. Structures: The integration of three ML structures aimed at enhancing misfire detection accuracy yielded promising results. Across different operational targets, the models showcased high overall accuracy rates, particularly in scenarios where misfires were both known and unknown. Notably, the models achieved up to 98% accuracy in identifying misfires, with capabilities extending to detecting isolated misfires and continuous misfire zones.

Real-World Applicability and Reliability: The study's findings highlight the practical applicability of advanced diagnostic tools in real-time misfire detection. With accuracies of approximately 95% to 98% in various operational scenarios, including cases beyond known operational ranges, the models prove reliable and effective. This reliability is crucial for optimizing combustion analysis in hydrogen-based engines, offering insights that can enhance operational efficiency and reliability.

The present disclosure underscores the transformative potential of ML and advanced analytical methods in improving combustion analysis for hydrogen-fueled internal combustion engines. The high accuracy rates achieved validate their role as pivotal tools for enhancing operational efficiency, reliability, and performance monitoring in automotive and industrial applications.

It is to be understood that the foregoing is a description of one or more preferred example embodiments. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all the following: “A”; “B”; “C”; “A and B”; “A and C”; “B and C”; and “A, B, and C.”

1. An ignition diagnostic method for use with an internal combustion engine (ICE), comprising the steps of:
providing an artificial intelligence (AI) model utilizing at least one machine learning (ML) algorithm, the AI model is configured to correlate information from diagnostic signals with combustion-related parameters;
receiving diagnostic signals from an ignition coil assembly that is associated with a cylinder in the ICE;
obtaining information from the received diagnostic signals;
inputting the obtained information into the AI model;
using the AI model and the inputted information to predict combustion-related parameters for the cylinder; and
using the predicted combustion-related parameters to determine if an abnormal combustion event has occurred in the cylinder.

2. The ignition diagnostic method of claim 1, wherein the internal combustion engine (ICE) is a hydrogen (H₂) engine.

3. The ignition diagnostic method of claim 1, wherein the providing step further comprises providing an artificial intelligence (AI) model that is configured to correlate information from diagnostic signals in the form of diagnostic signal lengths (Diag) with combustion-related parameters in the form of in-cylinder pressure values (P).

4. The ignition diagnostic method of claim 3, wherein the diagnostic signal lengths (Diag) include information that is representative of both a charging phase of the ignition coil assembly and a discharging phase of the ignition coil assembly.

5. The ignition diagnostic method of claim 4, wherein the information representative of a charging phase of the ignition coil assembly corresponds to an amount of time taken for a charging current to exceed a charging current threshold and is representative of a state or a condition of a primary winding in the ignition coil assembly.

6. The ignition diagnostic method of claim 4, wherein the information representative of a discharging phase of the ignition coil assembly corresponds to an amount of time taken for a discharging current to fall below a discharging current threshold and is representative of a state or a condition of a secondary winding in the ignition coil assembly or of a corresponding spark plug.

7. The ignition diagnostic method of claim 1, wherein the at least one machine learning (ML) algorithm predicts a maximum in-cylinder pressure (Pₘₐₓ), and the predicted maximum in-cylinder pressure (Pₘₐₓ) is used to determine if an abnormal combustion event has occurred in the cylinder.

8. The ignition diagnostic method of claim 1, wherein the at least one machine learning (ML) algorithm predicts in-cylinder pressure trends (P_{cyl trend}), the predicted in-cylinder pressure trends (P_{cyl trend}) are used to compute a maximum in-cylinder pressure (Pₘₐₓ), and the computed maximum in-cylinder pressure (Pₘₐₓ) is used to determine if an abnormal combustion event has occurred.

9. The ignition diagnostic method of claim 1, wherein the first using step further comprises using the AI model and the inputted information to predict a maximum in-cylinder pressure (Pₘₐₓ), and the second using step further comprises comparing the predicted maximum in-cylinder pressure (Pₘₐₓ) to a maximum cylinder pressure threshold to return a binary output, when the binary output is a certain value, the second using step determines that an abnormal combustion event has occurred in the cylinder.

10. The ignition diagnostic method of claim 1, wherein the second using step further comprises comparing a predicted maximum in-cylinder pressure (Pₘₐₓ) to a maximum cylinder pressure threshold and, when the predicted maximum in-cylinder pressure (Pₘₐₓ) is less than the maximum cylinder pressure threshold, determining that an abnormal combustion event has occurred in the cylinder.

11. The ignition diagnostic method of claim 1, wherein the method further comprises evaluating correlations between the diagnostic signals and one or more of the following parameter(s): voltage demand, spark advance, secondary current and/or primary current.

12. The ignition diagnostic method of claim 1, wherein the artificial intelligence (AI) model includes a plurality of machine learning (ML) algorithms, and the output of each of the plurality of ML algorithms is weighted so that the method arrives at an overall determination if an abnormal combustion event has occurred in the cylinder.

13. The ignition diagnostic method of claim 1, wherein the ignition diagnostic method is part of a dual-method approach that combines a simplified analytical framework with a genetic algorithm (GA), the dual-method approach uses a diagnostic signal length (Diag) and one or more parameter(s) provided by an electronic control unit (ECU) to classify combustion events as regular combustion events or abnormal combustion events, and also provides an estimated maximum in-cylinder pressure (Pₘₐₓ).

14. An ignition diagnostic system for use with an internal combustion engine (ICE), comprising:
an electronic storage device with an artificial intelligence (AI) model having at least one machine learning (ML) algorithm stored thereon, the AI model is configured to correlate information from diagnostic signals with combustion-related parameters;
wherein the ignition diagnostic system is coupled to an ignition coil assembly that is associated with a cylinder in the ICE and is configured to:
receive diagnostic signals from the ignition coil assembly;
obtain information from the received diagnostic signals;
input the obtained information into the AI model;
use the AI model and the inputted information to predict combustion-related parameters for the cylinder; and
use the predicted combustion-related parameters to determine if an abnormal combustion event has occurred in the cylinder.

15. The ignition diagnostic system of claim 14, wherein the internal combustion engine (ICE) is a hydrogen (H₂) engine.

16. The ignition diagnostic system of claim 14, wherein the at least one machine learning (ML) algorithm predicts a maximum in-cylinder pressure (Pₘₐₓ), and the predicted maximum in-cylinder pressure (Pₘₐₓ) is used to determine if an abnormal combustion event has occurred in the cylinder.

17. The ignition diagnostic system of claim 14, wherein the at least one machine learning (ML) algorithm predicts in-cylinder pressure trends (P_{cyl trend}), the predicted in-cylinder pressure trends (P_{cyl trend}) are used to compute a maximum in-cylinder pressure (Pₘₐₓ), and the computed maximum in-cylinder pressure (Pₘₐₓ) is used to determine if an abnormal combustion event has occurred.

18. The ignition diagnostic system of claim 14, wherein the at least one machine learning (ML) algorithm predicts a maximum in-cylinder pressure (Pₘₐₓ), compares the predicted maximum in-cylinder pressure (Pₘₐₓ) to a maximum cylinder pressure threshold to return a binary output, and when the binary output is a certain value, determines that an abnormal combustion event has occurred in the cylinder.

19. The ignition diagnostic system of claim 14, wherein the ignition diagnostic system is further configured to compare a predicted maximum in-cylinder pressure (Pₘₐₓ) to a maximum cylinder pressure threshold and, when the predicted maximum in-cylinder pressure (Pₘₐₓ) is less than the maximum cylinder pressure threshold, determine that an abnormal combustion event has occurred in the cylinder.
